(19) United States
(12) Patent Application Publication
(10) Pub. No.: US 2024/0110975 A1
(43) Pub. Date: Apr. 4, 2024

(54) Secure Remote Debugging

(71) Applicant: Intel Corporation, Santa Clara, CA (US)

(72) Inventors: Tsvika Kurts, Haifa (IL); Vladislav Mladentsev, Haifa (IL); Elias Khoury, Haifa (IL); Rakesh Kandula, Doddakannelli (IN); Reuven Elbaum, Haifa (IL); Boris Dolgunov, San Jose, CA (US)

(73) Assignee: Intel Corporation, Santa Clara, CA (US)

(21) Appl. No.: 17/958,071

(22) Filed: Sep. 30, 2022

(51) Int. Cl. G01R 31/317; H04L 9/08; H04L 9/32; H04L 9/40

(52) U.S. Cl. CPC G01R 31/31719; H04L 9/0819; H04L 9/0866; H04L 9/0869; H04L 9/3213; H04L 63/0428

(57) ABSTRACT

Methods and apparatus relating to techniques to provide secure remote debugging are described. In an embodiment, a debugging entity generates and transmits a host token to a device via an interface. The interface provides encrypted communication between the debugging entity and the device. The debugging entity generates a session key based at least in part on the host token and a device token. The debugging entity transmits an acknowledgement signal to the device after generation of the session key to initiate a debug session. The debugging entity transmits a debug unlock key to the device to cause the device to be unlocked for the debug session. Other embodiments are also disclosed and claimed.

### FIELD

The present disclosure generally relates to the field of computing security. More particularly, some embodiments relate to techniques to provide secure remote debugging.

### BACKGROUND

Modern electronic devices tend to include at least one integrated circuit device. These integrated circuit devices may take on a variety of forms, including processors (e.g., Central Processing Units (CPUs)), memory devices, and programmable devices (such as Field Programmable Gate Arrays (FPGAs), to name only a few examples.

In some instances, an integrated circuit device may not function as intended. To identify and correct errors causing the unintended functionality, the integrated circuit device may have to be first unlocked (e.g., made fully accessible) for a debugging process. However, debugging the unlocked integrated circuit device may unintentionally expose various details regarding the device to unauthorized parties.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 depicts a microarchitecture of a System Under Test (SUT) which may be used to facilitate a remote debug process, in accordance with an embodiment.

FIG. 2 illustrates a flow diagram of a method to provide remote debug, according to an embodiment.

FIG. 3 illustrates a diagram for a key exchange flow, according to an embodiment.

FIG. 4 illustrates a debugging system that performs the remote debug process for an integrated circuit device, in accordance with an embodiment.

FIG. 5 illustrates an example computing system.

FIG. 6 illustrates a block diagram of an example processor and/or System on a Chip (SoC) that may have one or more cores and an integrated memory controller.

FIG. 7(A) is a block diagram illustrating both an example in-order pipeline and an example register renaming, out-of-order issue/execution pipeline according to examples.

FIG. 7(B) is a block diagram illustrating both an example in-order architecture core and an example register renaming, out-of-order issue/execution architecture core to be included in a processor according to examples.

FIG. 8 illustrates examples of execution unit(s) circuitry.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, debugging a malfunctioning integrated circuit device may unintentionally expose device information to unauthorized parties.

To this end, some embodiments provide techniques to support secure remote debugging. More particularly, one or more embodiments provide multiple protection mechanisms against various physical and/or offline attacks in a remote debug implementation. The protection may be implemented at multiple points which can be sensitive to such attack(s). An embodiment proposes a more security robust remote debug implementation which may protect against physical attacks and/or reverse engineering attacks.

As an example, Intel® Corporation of Santa Clara, California, provides an encrypted Debug (“enDebug”™) feature in some System on Chip (“SoC” or “SOC”) devices to improve customer support, e.g., by allowing debugging of features implemented in the integrated circuit logic of an SoC remotely. This feature aims to allow for fast and flexible customer support without making security compromises. Some implementations allow enDebug to also provide protection against some cyber-attacks and/or physical attacks (such as side-channel attacks, timing attacks, quantum brute force attacks, and direct physical attacks on the keys in the SoC). The addition of such protections allows for improvement of enDebug security and mitigation of more sophisticated security attacks such as reverse engineering and side channel attacks.

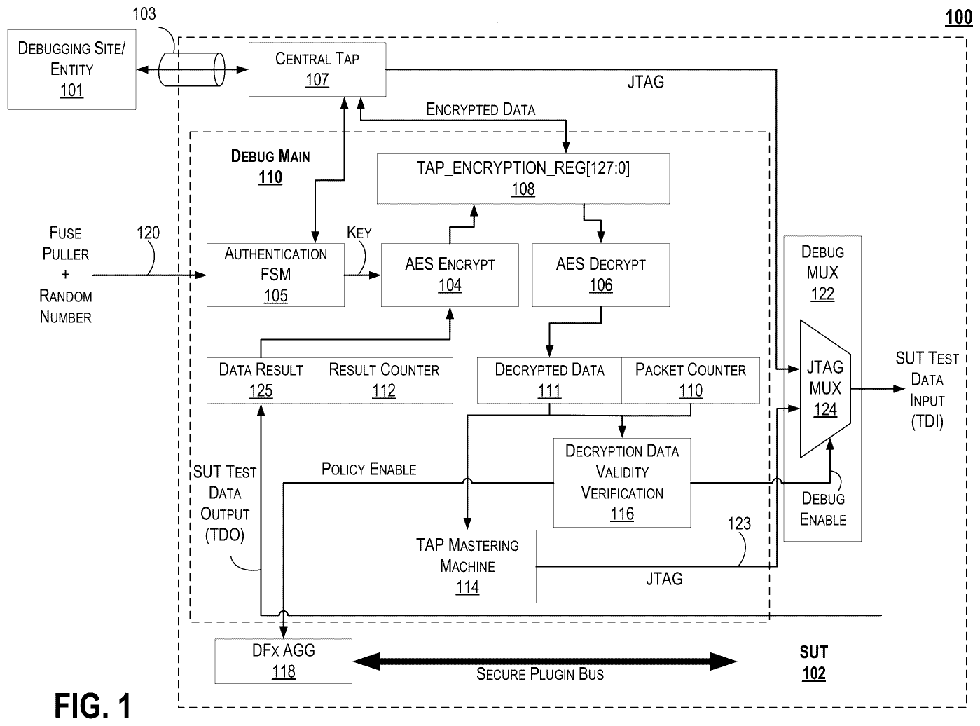

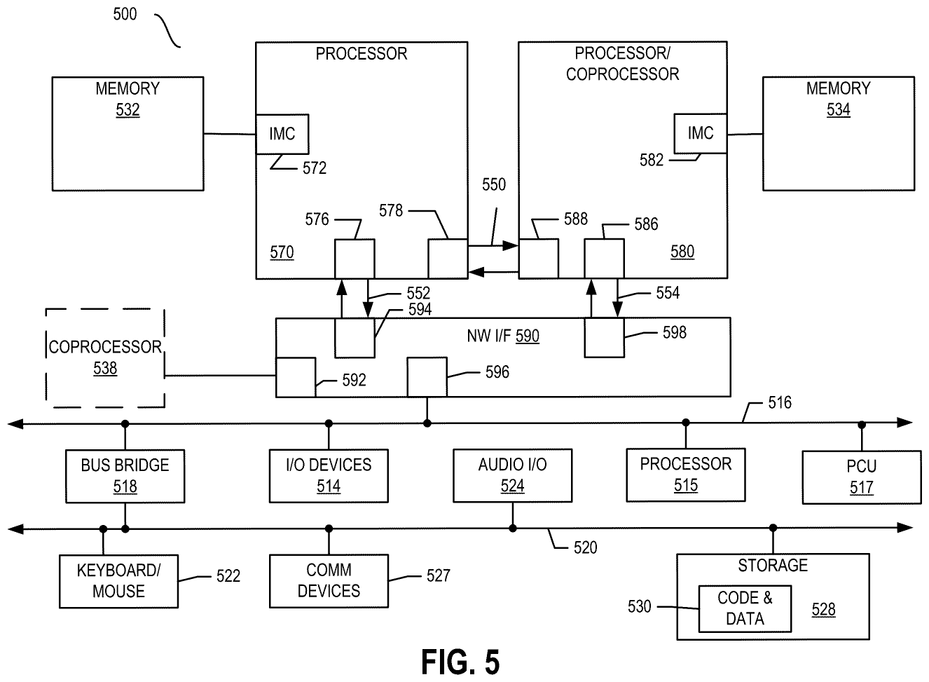

FIG. 1 depicts a microarchitecture 100 of a System Under Test (SUT) 102 which may be used to facilitate a remote debug process, in accordance with an embodiment. As shown, a debugging site/entity 101 may communicate with a SUT 102 via an encrypted/protected communication channel 103. Debugging of the SUT 102 may involve the debugging of individual components of the SUT 102, such as an integrated circuit device (including one or more cores of a processor, etc.). The channel 103 may transmit encrypted Instruction Register (IR) and/or Data Register (DR) commands. The SUT 102 may include an authentication Finite State Machine (FSM) 105, an Advanced Encryption Standard (AES) encryption machine/logic 104, an AES decryption machine/logic 106, a (e.g., central) Test Access Port (TAP) 107, a TAP encryption register 108, a packet counter 110, a result counter 112, a TAP mastering machine/logic 114 (for fuses acquired through a functional system bus), and a decryption data validity verification block 116. These components may control the remote debug process behavior, evaluate debug status information, and perform the remote debug process. Also, the SUT 102 and/or debugging site 101 may optionally include various other components such as one or more of the components discussed with reference to FIG. 5 et seq.

Generally, the enDebug technology allows for remote debug from any supported location (e.g., the debugging site 101) to remote customers sites (e.g., DUT 102 which may be located in a physically separate location, such as in another country, on another continents, etc.) without the need for attendance of an authorized employee at the customer's site to perform the debug. All accesses performed through the public Internet may be secured, e.g., via a secured end-to-end channel. This may be achieved by implementing an encryption/decryption hardware logic (such as the Central TAP 107 of a Central Processing Unit (CPU) or processor), which may be complemented with by a software layer executed over one or more relay servers.

Moreover, the debug generally works as follows: assuming there is a customer issue (e.g., a hang in operations) and a debug of the architecture state of CPU is to be performed: protected (e.g., Joint Test Action Group (JTAG)) commands (e.g., encrypted over public network(s)) are sent from a debug origination/control site to a customer's SUT, then decrypted inside the CPU which performs internally Array Freeze and Dump (AFD) and encrypts the results and sends them back to debug origination/control site. Debug can be continued interactively until a root cause is detected.

In some implementations, enDebug may be implemented as a separate Intellectual Property (IP) logic block which is connected to the TAP root (e.g., the central TAP 107) and has the ability to take control over the TAP network when a enDebug session is activated. After activation, only encrypted TAP commands are permitted and all other commands are blocked.

One or more embodiments may utilize a Design for Manufacturability, Testability, and Debuggability (DFx) module/logic (developed by Intel Corporation) called DFX Aggregator 118 (DFX AGG) to enforce security life cycle states. However, embodiments are not limited to a DFx and any module may be used to enforce security life cycle states in a device. Logic 118 may enforce a special “secured privilege level” when enDebug is used. With this policy, a device allows privileged access through a secured TAP but will disable any other debug features that may be controlled by software on the device. Each hardware block may receive a (e.g., DFx) lifecycle policy or a secured privilege level and would enforce it accordingly. Since such an implementation of enDebug has a privileged TAP permission in the system and practically allows access to any protected IP feature, it is important to protect confidentiality. The feature is generally designed to encrypt input and output data, authenticate trusted host and check integrity of all TAP commands sent between host and the SoC TAP network. Random session keys may be used for data encryption and integrity verification. Also, new key(s) may be created for each enDebug session.

To create an enDebug session, a trusted host (such as the debugging site 101) would know a device's unique authentication key that is used for key exchange and authentication. In an embodiment, this authentication key may be generated during device manufacturing and stored in One-Time Programmable (OTP) memory such as fuses. In turn, the trusted host reads the unit identifier and extracts the relevant key from the iSeed database in some implementations.

After initialization of the session, enDebug hardware creates a random session key using a Digital Random Number Generator (DRNG) and encrypts it using authentication key from the fuses. The host, in turn, decrypts the session key and uses it to communicate with the device. An enDebug secure channel will assure enDebug confidentiality and integrity protection of the data sent to/from the device.

Special attention is given to the mechanism that does not allow replay of the session by a malicious software. A special counter may be inserted as an integral part of each encrypted JTAG command result which ensures a continuous forward progress to block any attempt of a replay session. TAP commands may be packetized in N-bit packets (e.g., 32-bit, 64-bit, 96-bit, 128-bit packets, etc.), where a part of the packet includes integrity information. Each 128-bit packet may be decrypted and verified by the enDebug IP.

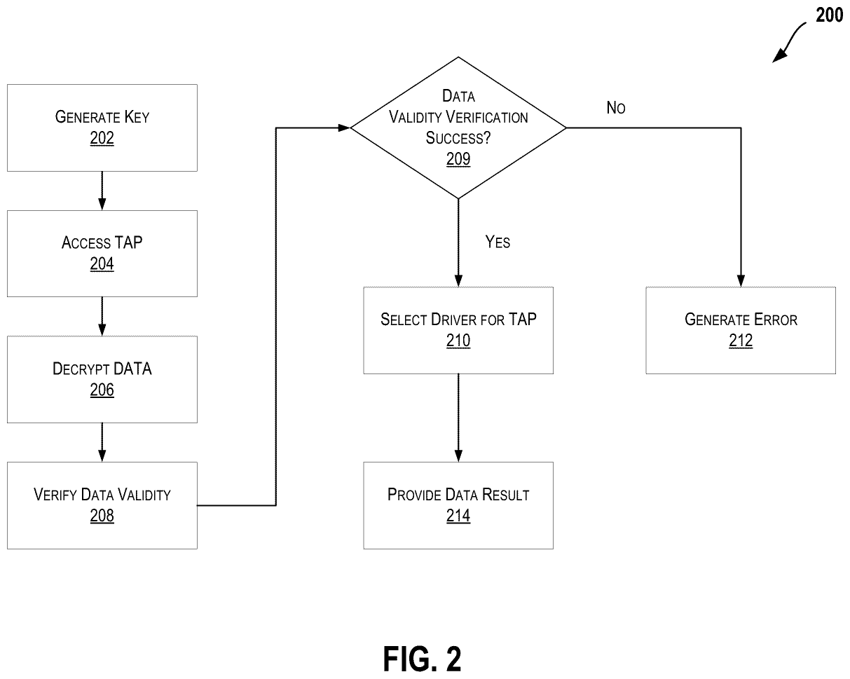

FIG. 2 illustrates a flow diagram of a method 200 to provide remote debug, according to an embodiment. One or more of the operations of method 200 may be performed by one or more components of the microarchitecture 100 of FIG. 1.

Referring to FIGS. 1 and 2, key generation is performed at an operation 202. During early boot, hardware logic circuitry (e.g., authentication FSM 105) reads authentication key(s) from fuses and a random number from a DRNG (120). When a user requests initiation of a enDebug session, the authentication FSM 105 generates a new random session key, encrypts it, and provides it to the host (e.g., debugging site 101). Thus new session key is then used for the rest of debug session. TAP access is performed at an operation 204. By using the session key (generated at operation 202), host software (e.g., at the debugging site 101) encrypts a requested TAP instruction and sends it as an input to an enDebug hardware (e.g., the central TAP 107) and to the tap encryption register (TAP_ENCRYPTION_REG 108). Thus, the encrypted TAP instructions may set-up implementation of the remote debug process session.

At an operation 206, the encrypted TAP instructions and/or other data may be decrypted using the AES decryption machine 106 using the session key which is unique for every new session as discussed with reference to operation 202. The decryption process may take some time. To avoid collisions, clock frequencies may be chosen and hardware designed in such a way that decryption is completed before the next TAP instruction is received (e.g., shifted into the TAP encryption register 108). enDebug logic may include an option to work with different clocks and configurable frequencies. In some embodiments, the remote debug process may modify different clocks and/or operating frequencies of a debugging system to meet timing demands of the decryption.

After data decryption of operation 206, at an operation 208, hardware (e.g., decryption data validity verification logic 116) checks the integrity and sequential number of every decrypted data/packet to prevent possible attacks. At this stage, a packet consists of decrypted data 111 and a counter 110. In at least one embodiment, protocol may require the first packet in debug session to be equal to an initial value (e.g., zero), and the counter to be incremented on every new packet. So, after decryption, hardware verifies whether the first packet is equal to the initial value to ensure that the session key is valid. Due to the fact that for each new session the session key is unique, this check prevents the save/replay attack. For each sub-sequent packet, hardware verifies that the value of decrypted packet counter matches the internal hardware decryption counter. This guarantees the integrity of debug session and prevents removing of packets in the middle of the stream. After all checks are performed, the decrypted data is sent to the TAP mastering machine 114.

Hence, in an embodiment, at operation 208, the packet counter 110 may be used by logic 116 to perform integrity checks of each decrypted data 111 to prevent unauthorized access by third parties. Each packet may include the data and a counter, as described above. During the remote debug process session, the first packet received contains a counter value equal to an initial value (e.g., zero) and each subsequent packet received will have a counter value that is incremented. Thus, the data verification block 116 may verify that the packet counter values match the internal packet counter 110 value and may ensure that the random session key is valid. Because of the incrementing counter values and because the random session key is unique for each session, the integrity check may prevent save and replay attacks by the third party as well as modification of the command data stream. Once checks of the decrypted data 111 have been performed, the decrypted data 111 may be sent to the TAP mastering machine 114. In particular, the AES decryption machine 106 may provide the decrypted data 111 in parallel to the busses and subsequently, to the TAP mastering machine 114.

In some embodiments, the central TAP 107, however, may use a serial interface for proper functionality. To convert from parallel to serial data transfer, the TAP mastering machine 114 may use an Institute of Electrical and Electronics Engineers (IEEE) standard for serial TAP protocol. Each decrypted packet generally has a standard width, while each TAP instruction may have a different length. The TAP Mastering Machine 114 may be flexible enough to provide access to any TAP register, with either short or long size, even for registers that are too long and require several packets for access. Hence, the TAP mastering machine 114 may provide data width conversion between the TAP instruction widths and the widths supported by the TAP registers of the central TAP 107.

From the TAP mastering machine 114, the decrypted data 111 may be transferred to a remote debug multiplexer (MUX) 122 via a JTAG interface 123. The remote debug MUX 122 may select appropriate drivers for the TAP network at operation 210, for example, by selecting the remote debug process mode after the decrypted data 111 passes the validity verification. By default, TAP network may be driven from the JTAG pins. Only after enDebug mode is requested and decrypted data successfully passed the validity verification at operation 209, the debug session is actually started and JTAG MUX 124 is switched to enDebug mode (via the debug enable signal to be generated by the decryption data validity verification logic 116). At this point, the remote debug process session may begin. Otherwise, if the verification at operation 209 fails, an operation 212 generates an error and drops the existing session. A user may be required to restart authentication and create a new secure session to continue debug.

At an operation 214, while accessing TAP registers, the TAP output data is generated and stored in data result 125. The data result is then encrypted (by AES encrypt logic 104) and send back to the user via the central TAP 107. For example, the data results 125 may include the information on the internal state(s) of a processor. The data results 125 may run through the result counter 112 that may add counter bit values to each packet of the data result 125. Once encrypted by the AES encryption machine 104, the data result 125 may be transmitted to the TAP encryption register 108, to the central TAP 107, through the secure channel built on the public network 103, and finally to the debugging site 101 for analysis.

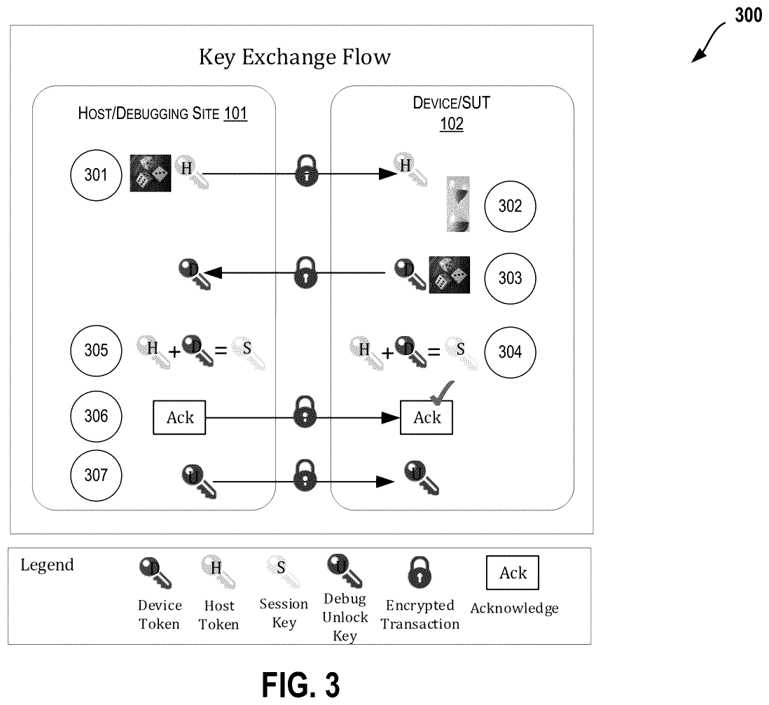

FIG. 3 illustrates a diagram for a key exchange flow 300, according to an embodiment. One or more of the operations of flow 300 may be performed by one or more components of the microarchitecture 100 of FIG. 1.

Referring to FIGS. 1 and 3, at an operation 301, a host (e.g., debugging site 101) generates a “Host Token” and transfer it to a device under test (e.g., SUT 102) with an encrypted transaction. At an operation 302, the device implements a special latency (e.g., of fixed or varying delay) during session start to prevent repetition of operation 303 rapidly and protecting operation 303 from side channel and brute force attacks. At an operation 303, the device generates a “Device Token” and transmits it to the host with an encrypted transaction. At an operation 304, the host generates a “Session Key” using both the “Host Token” and “Device Token”. At an operation 305, the device generates a “Session Key” using both the “Host Token” and “Device Token”. At an operation 306, the host transmits a predetermined acknowledge packet or signal to the device with an encrypted transaction to establish a debug session. At an operation 307, the host transmits a Debug Unlock key to the device with an encrypted transaction to unlock the device for debug. The Debug Unlock key is a unique device key randomly assigned during device manufacturing. It may be stored in secure database at or under the control of a manufacturer or developer. A hash of this key may also be stored in the device fuses.

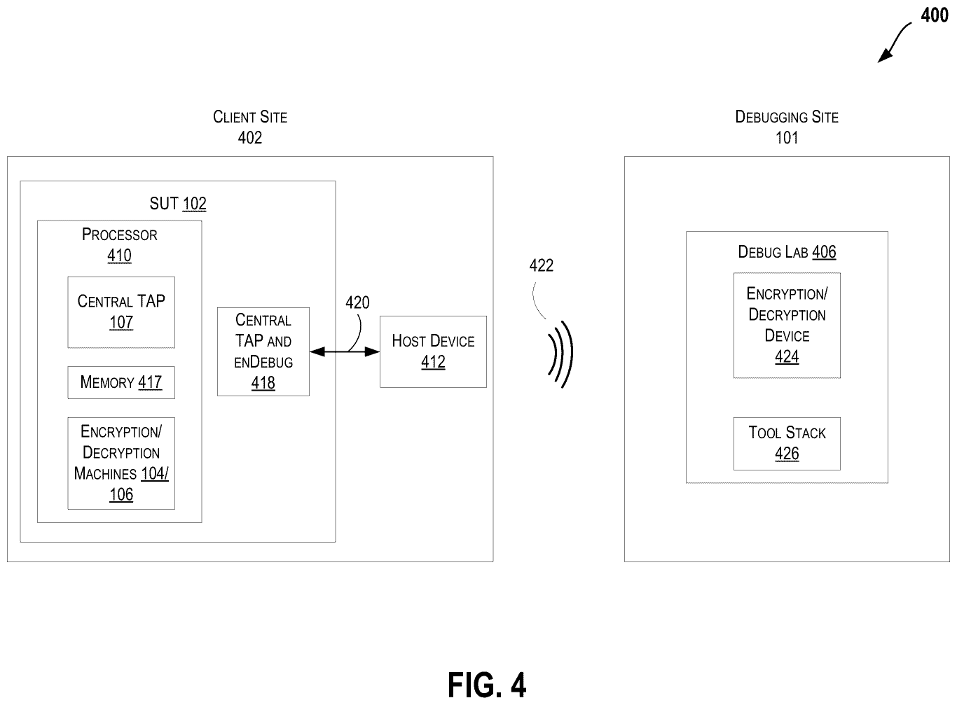

FIG. 4 illustrates a debugging system 400 that performs the remote debug process for an integrated circuit device, in accordance with an embodiment. As shown, the debugging system 400 includes a client site 402, such as a client lab that uses an integrated circuit device for application implementations. Further, the debugging system 400 includes a remote debugging site 101 that includes a debug lab for remotely determining the root cause of the operation error. For example, when the debugging site 101 is located away (e.g., different countries) from the client site 402, the debugging site 101 may remotely assess (e.g., via public Internet connections) an integrated circuit device to determine the root cause of the error.

The client site 402, in particular, may include the integrated circuit device (e.g., in a system under test (SUT) 102) that is under the remote debug process. The SUT 102 may in turn include a processor 410 (e.g., the afore-mentioned integrated circuit device) that may be debugged by one or more debug labs 406 at the debugging site 101 and/or another location. The debug lab 406 may communicate with the processor 410 via a client-side host device 412 that is communicatively coupled to the processor 410 and to the debugging site 101. To facilitate debugging of the SUT 102, the processor 410 may include a central network TAP 107 that enables access to/from a network used by the SUT 102. In addition, the SUT 102 may include remote debug IP, such as an encryption/decryption machines 104/106, a Central TAP and enDebug logic 418 used to facilitate the debug process, other IP to be protected in the processor 410, and memory 417 that may store information (e.g., random session keys) to facilitate the remote debug process. In some embodiments, the memory 417 may be part of the processor 410 or external to the processor 410.

Briefly, the remote debug process may be initiated by the client using, for example, the client site host device 412 when an unexpected error occurs during testing and/or implementation of the SUT 102 at the client site 402. In such instances, the client may request that the remote debug process be performed on the SUT 102 by the debug labs 406. The request, in particular, may include authorization for initiating the remote debug process by the debug labs 406 and/or a certificate that identifies the client, the SUT 102, the processor 410, and/or other relevant information. The request may be encrypted by the remote debug IP, communicated to the client site host device 412 via a Joint Test Action Group (JTAG) interface 420, and ultimately transmitted to the debugging site 101 from the client site host device 412 over a public network 422.

Once the debug labs 406 verify the client and the SUT 102, JTAG commands may be encrypted by the encryption/decryption device 424 at the debugging site 101 and may be transmitted to the client site host device 412 via the public network 422. The type of JTAG commands sent may be based on the nature of the error. For example, when the error is a hang (e.g., system freeze), a debugger of the debug lab 406 may analyze information on internal node states of the processor 410 and thus, the JTAG commands may include instructions for performing an internal Array Freeze and Dump (AFD) of processor arrays.

The JTAG commands may be transferred from the client site host device 412 to the SUT 102 via the JTAG interface 420. Specifically, the central TAP 107 may receive the encrypted/protected JTAG commands for AFD and/or other interactions and subsequently transfer the JTAG commands to the encryption/decryption machines 104/106 to decrypt the JTAG commands using a secure session key, as will be discussed in further detail below. The internal encryption and decryption capabilities provided by the encryption/decryption machines 104/106 may further protect data transmitted between the debugging site 101 and the client site 402 since unencrypted data may not be exposed to tracking by an unauthorized third party (e.g., hacker) during transfer between the sites 402, 101.

Once decrypted, the remote debug process session may be active and the TAP network may be modified to allow encrypted TAP commands to be passed through to the client site 402 and/or the debugging site 101 while blocking other types of non-encrypted commands. In other words, once the remote debug process session is active (e.g., remote debug SoC state is enabled), a remote debug security policy (e.g., enable debug mode) may be implemented to enable unlocked and/or elevated TAP access of the SUT 102 IP while encrypting data that is input to and/or output from the client site host device, authenticating the client site host device 412, and verifying integrity of TAP commands sent between the debugging site 101 and the client site 402 via the secure session key, as discussed herein.

The debug function encoded by the JTAG command may be executed by the SUT 102 as if the SUT 102 were located within the debug labs 406 as opposed to the client site 402. For example, the processor 410 may perform the AFD by copying the internal state(s) of SUT array(s) and thus, preserving information about the implementation environment. The encryption/decryption machines 104/106 may subsequently encrypt this internal state information and transmit this information to the client site host device 412 and to the debug labs 406 via the public network 422. The designer may decrypt the information using the encryption/decryption device 424 and may analyze the internal state(s) using a debug tool, such as a tool stack 426 that gathers stack information during a debug mode. In some embodiments, the remote debug process may continue until the root cause of the error is identified. Additionally or alternatively, the process may pause after the AFD is passed to the debugging site 101 until analysis of the dump is completed. Then, the remote debug process may continue. It should be understood that the term “designer” may include any entity that fabricates or designs the integrated circuit device 102, such that the entity has elevated permission to access IP of the device 102. In some cases, this may be a party responsible for a particular component of the device 102 (e.g., a particular IP module, a particular aspect of a circuit design programmed onto programmable logic of the device 102).

Accordingly, one or more embodiments eliminate (or at least mitigate) protocol and/or physical attack weaknesses as follows:
1. Direct key extraction from fuses—enDebug uses a unique authentication key for authentication with the debug host. This authentication key may be extracted through a fuse reverse engineering attack. To mitigate this attack vector, enDebug implements a metal key used to encrypt and protect a fuse key (where an encrypted key value is stored by fuses and, in turn, a new metal key is used to decrypt the stored/encrypted fuse value before use) in an embodiment.
2. Protection against postquantum attacks: with development of the quantum computers 128-bit keys may not be strong enough against brute force attacks. Using post quantum computers, it may be possible to implement offline brute force on the attack on the authentication key. To mitigate against that attack, the enDebug key size may be increased to the 256 bits, 512 bits, and beyond.
3. Protection against side channel attacks—enDebug IP uses cryptographic protection for the authentication, encryption and integrity protection. Straightforward implementation may be attacked using side channel attacks. In the enDebug IP, however, may implement two different protections against this attack vector:
   (a) delay of about 1 sec between two authentications to prevent an attacker that collects a large number of power samples for the analysis of encryption operations performed with the device token; and/or
   (b) use a side-channel protected AES engine that implements random masking of the intermediate calculation results.
4. DRNG malfunction protection—enDebug IP uses SoC DRNG for session key generation. This DRNG may be attacked using fault attacks that causing generation of weak (repeating) numbers. To mitigate this attack vector, an internal detection logic is implemented in the enDebug IP itself (e.g., within the SUT 102) to detect this situation and cause generation of stronger random numbers.
5. Improvement of the key exchange flow. In the first version of enDebug, a half-duplex key generation is used. Hence, only enDebug IP (SoC) participated in generation of this session key. In the new generation, both sides (host and SoC/device) generate session key components (see, e.g., FIG. 3). This mitigates potential DRNG entropy weaknesses.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 5 illustrates an example computing system. Multiprocessor system 500 is an interfaced system and includes a plurality of processors or cores including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a system on a chip (SoC).

Processors 570 and 580 are shown including integrated memory controller (IMC) circuitry 572 and 582, respectively. Processor 570 also includes interface circuits 576 and 578; similarly, second processor 580 includes interface circuits 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect or another I/O interconnect. In some examples, first interface 516 is coupled to a power control unit (PCU) 517, which may include circuitry, software, and/or firmware to perform power management operations with regard to the processors 570, 580 and/or co-processor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage for one or more instructions in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

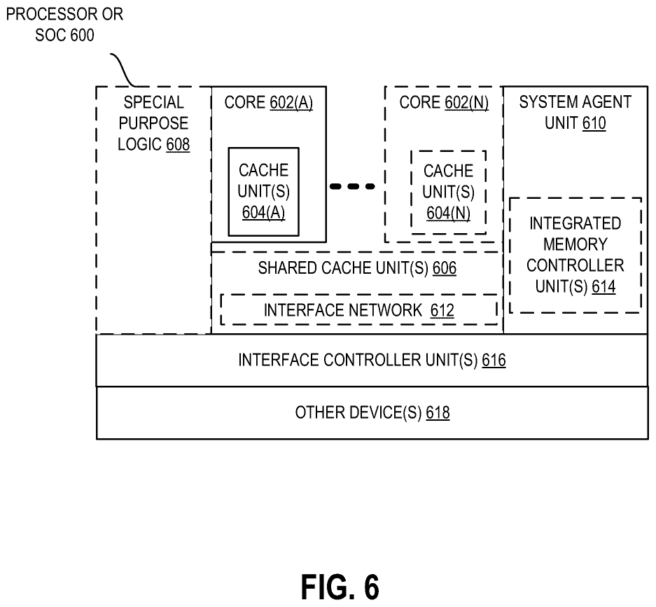

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

### Example Core Architectures—In-Order and Out-of-Order Core Block Diagram

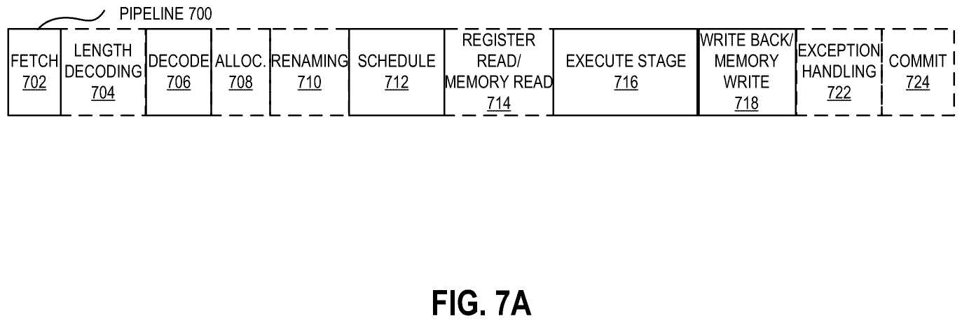

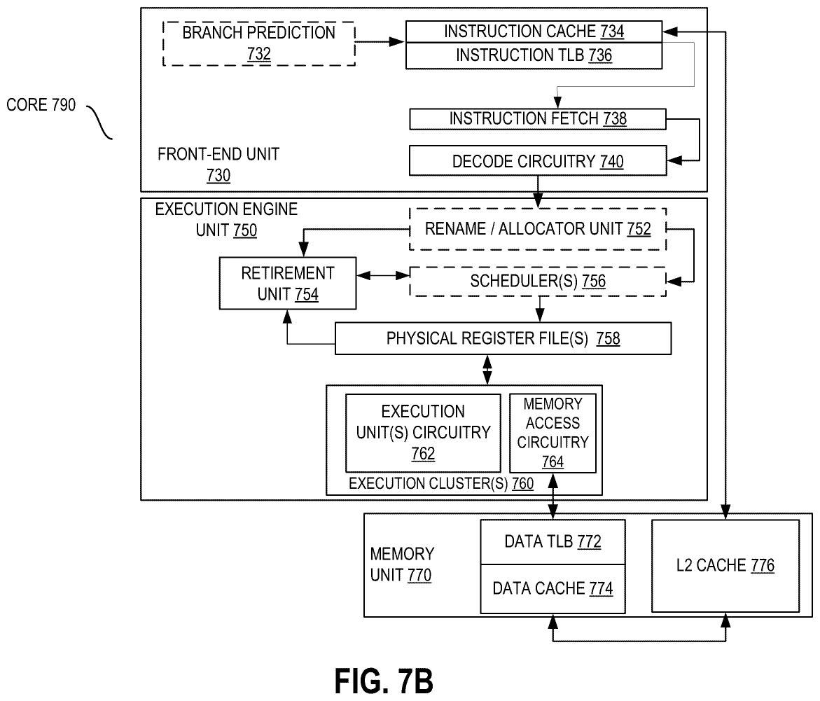

FIG. 7(A) is a block diagram illustrating both an example in-order pipeline and an example register renaming, out-of-order issue/execution pipeline according to examples. FIG. 7(B) is a block diagram illustrating both an example in-order architecture core and an example register renaming, out-of-order issue/execution architecture core to be included in a processor according to examples. The solid lined boxes in FIGS. 7(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7(A), a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7(B) may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7(B) shows a processor core 790 including front-end unit circuitry 730 coupled to execution engine unit circuitry 750, and both are coupled to memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to data cache circuitry 774 coupled to level 2 (L2) cache circuitry 776. In one example, the memory access circuitry 764 may include load unit circuitry, store address unit circuitry, and store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, level 3 (L3) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

### Example Execution Unit(s) Circuitry

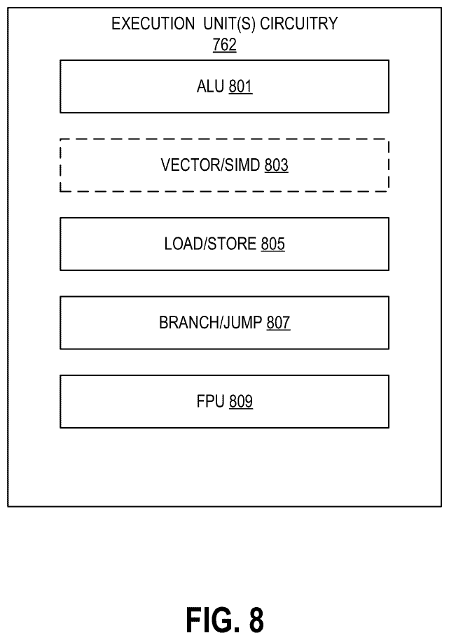

FIG. 8 illustrates examples of execution unit(s) circuitry, such as execution unit(s) circuitry 762 of FIG. 7(B). As illustrated, execution unit(s) circuitry 762 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: a debugging entity to generate and transmit a host token to a device via an interface, wherein the interface is to provide encrypted communication between the debugging entity and the device; and the debugging entity to generate a session key based at least in part on the host token and a device token, wherein the debugging entity is to transmit an acknowledgement signal to the device after generation of the session key to initiate a debug session, wherein the debugging entity is to transmit a debug unlock key to the device to cause the device to be unlocked for the debug session.

Example 2 includes the apparatus of example 1, wherein the device comprises one of: a device under test, a system under test, an integrated circuit device, and a processor. Example 3 includes the apparatus of example 1, wherein the device is to implement brute force and side channel protection through a special latency delay during session start in response to receipt of the host token at the device. Example 4 includes the apparatus of example 1, wherein the device is to generate the device token in in response to receipt of a host token from the debugging entity. Example 5 includes the apparatus of example 1, wherein the device is to generate the session key based at least in part on the host token and the device token. Example 6 includes the apparatus of example 1, wherein the interface is to provide encrypted communication between the debugging entity and the device based at least in part on the session key. Example 7 includes the apparatus of example 1, further comprising an authentication finite state machine to generate the session key based at least in part on one or more stored fuse values and a random number. Example 8 includes the apparatus of example 7, wherein the fuse values are encrypted prior to storage. Example 9 includes the apparatus of example 8, wherein the encrypted stored fuse values are to be decrypted prior to use by the authentication finite state machine. Example 10 includes the apparatus of example 1, wherein the device comprises logic to detect a fault attack to cause generation of a weak random number.

Example 11 includes one or more non-transitory computer-readable media comprising one or more instructions that when executed on a processor configure the processor to perform one or more operations to: cause a debugging entity to generate and transmit a host token to a device via an interface, wherein the interface is to provide encrypted communication between the debugging entity and the device; generate a session key based at least in part on the host token and a device token; cause the debugging entity to transmit an acknowledgement signal to the device after generation of the session key to initiate a debug session; and cause the debugging entity to transmit a debug unlock key to the device to cause the device to be unlocked for the debug session.

Example 12 includes the one or more computer-readable media of example 11, wherein the device comprises one of: a device under test, a system under test, an integrated circuit device, and a processor. Example 13 includes the one or more computer-readable media of example 11, further comprising one or more instructions that when executed on the processor configure the processor to perform one or more operations to cause the device to implement brute force and side channel protection through a special latency delay during session start in response to receipt of the host token at the device. Example 14 includes the one or more computer-readable media of example 11, further comprising one or more instructions that when executed on the processor configure the processor to perform one or more operations to cause the device to generate the device token in in response to receipt of a host token from the debugging entity. Example 15 includes the one or more computer-readable media of example 11, further comprising one or more instructions that when executed on the processor configure the processor to perform one or more operations to cause the device to generate the session key based at least in part on the host token and the device token.

Example 16 includes the one or more computer-readable media of example 11, further comprising one or more instructions that when executed on the processor configure the processor to perform one or more operations to cause the interface to provide encrypted communication between the debugging entity and the device based at least in part on the session key. Example 17 includes the one or more computer-readable media of example 11, further comprising one or more instructions that when executed on the processor configure the processor to perform one or more operations to cause an authentication finite state machine to generate the session key based at least in part on one or more stored fuse values and a random number. Example 18 includes the one or more computer-readable media of example 17, further comprising one or more instructions that when executed on the processor configure the processor to perform one or more operations to cause the fuse values to be encrypted prior to storage. Example 19 includes the one or more computer-readable media of example 18, further comprising one or more instructions that when executed on the processor configure the processor to perform one or more operations to cause the encrypted stored fuse values to be decrypted prior to use by the authentication finite state machine.

Example 20 includes a method comprising: generating and transmitting, at a debugging entity, a host token to a device via an interface, wherein the interface provides encrypted communication between the debugging entity and the device; generating a session key based at least in part on the host token and a device token; transmitting, at the debugging entity, an acknowledgement signal to the device after generation of the session key to initiate a debug session; and transmitting, at the debugging entity, a debug unlock key to the device to cause the device to be unlocked for the debug session.

Example 21 includes the method of example 20, wherein the device comprises one of: a device under test, a system under test, an integrated circuit device, and a processor. Example 22 includes the method of example 20, further comprising the device implementing brute force and side channel protection through a special latency delay during session start in response to receipt of the host token at the device. Example 23 includes the method of example 20, further comprising the device generating the device token in in response to receipt of a host token from the debugging entity. Example 24 includes the method of example 20, further comprising the device generating the session key based at least in part on the host token and the device token. Example 25 includes the method of example 20, further comprising the interface providing encrypted communication between the debugging entity and the device based at least in part on the session key.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Further, While various embodiments described herein use the term System-on-a-Chip or System-on-Chip (“SoC” or “SOC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems, the various dies, tiles and/or chiplets can be physically and/or electrically coupled together by a package structure including, for example, various packaging substrates, interposers, active interposers, photonic interposers, interconnect bridges, and the like. The disaggregated collection of discrete dies, tiles, and/or chiplets can also be part of a System-on-Package (“SoP”).

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a debugging entity to generate and transmit a host token to a device via an interface, wherein the interface is to provide encrypted communication between the debugging entity and the device; and
the debugging entity to generate a session key based at least in part on the host token and a device token,
wherein the debugging entity is to transmit an acknowledgement signal to the device after generation of the session key to initiate a debug session, wherein the debugging entity is to transmit a debug unlock key to the device to cause the device to be unlocked for the debug session.

2. The apparatus of claim 1, wherein the device comprises one of: a device under test, a system under test, an integrated circuit device, and a processor.

3. The apparatus of claim 1, wherein the device is to implement brute force and side channel protection through a special latency delay during session start in response to receipt of the host token at the device.

4. The apparatus of claim 1, wherein the device is to generate the device token in in response to receipt of a host token from the debugging entity.

5. The apparatus of claim 1, wherein the device is to generate the session key based at least in part on the host token and the device token.

6. The apparatus of claim 1, wherein the interface is to provide encrypted communication between the debugging entity and the device based at least in part on the session key.

7. The apparatus of claim 1, further comprising an authentication finite state machine to generate the session key based at least in part on one or more stored fuse values and a random number.

8. The apparatus of claim 7, wherein the fuse values are encrypted prior to storage.

9. The apparatus of claim 8, wherein the encrypted stored fuse values are to be decrypted prior to use by the authentication finite state machine.

10. The apparatus of claim 1, wherein the device comprises logic to detect a fault attack to cause generation of a weak random number.

11. One or more non-transitory computer-readable media comprising one or more instructions that when executed on a processor configure the processor to perform one or more operations to:
cause a debugging entity to generate and transmit a host token to a device via an interface, wherein the interface is to provide encrypted communication between the debugging entity and the device;
generate a session key based at least in part on the host token and a device token;
cause the debugging entity to transmit an acknowledgement signal to the device after generation of the session key to initiate a debug session; and
cause the debugging entity to transmit a debug unlock key to the device to cause the device to be unlocked for the debug session.

12. The one or more computer-readable media of claim 11, wherein the device comprises one of: a device under test, a system under test, an integrated circuit device, and a processor.

13. The one or more computer-readable media of claim 11, further comprising one or more instructions that when executed on the processor configure the processor to perform one or more operations to cause the device to implement brute force and side channel protection through a special latency delay during session start in response to receipt of the host token at the device.

14. The one or more computer-readable media of claim 11, further comprising one or more instructions that when executed on the processor configure the processor to perform one or more operations to cause the device to generate the device token in in response to receipt of a host token from the debugging entity.

15. The one or more computer-readable media of claim 11, further comprising one or more instructions that when executed on the processor configure the processor to perform one or more operations to cause the device to generate the session key based at least in part on the host token and the device token.

16. The one or more computer-readable media of claim 11, further comprising one or more instructions that when executed on the processor configure the processor to perform one or more operations to cause the interface to provide encrypted communication between the debugging entity and the device based at least in part on the session key.

17. The one or more computer-readable media of claim 11, further comprising one or more instructions that when executed on the processor configure the processor to perform one or more operations to cause an authentication finite state machine to generate the session key based at least in part on one or more stored fuse values and a random number.

18. The one or more computer-readable media of claim 17, further comprising one or more instructions that when executed on the processor configure the processor to perform one or more operations to cause the fuse values to be encrypted prior to storage.

19. The one or more computer-readable media of claim 18, further comprising one or more instructions that when executed on the processor configure the processor to perform one or more operations to cause the encrypted stored fuse values to be decrypted prior to use by the authentication finite state machine.

20. A method comprising:
generating and transmitting, at a debugging entity, a host token to a device via an interface, wherein the interface provides encrypted communication between the debugging entity and the device;
generating a session key based at least in part on the host token and a device token;
transmitting, at the debugging entity, an acknowledgement signal to the device after generation of the session key to initiate a debug session; and
transmitting, at the debugging entity, a debug unlock key to the device to cause the device to be unlocked for the debug session.

21. The method of claim 20, wherein the device comprises one of: a device under test, a system under test, an integrated circuit device, and a processor.

22. The method of claim 20, further comprising the device implementing brute force and side channel protection through a special latency delay during session start in response to receipt of the host token at the device.

23. The method of claim 20, further comprising the device generating the device token in in response to receipt of a host token from the debugging entity.

24. The method of claim 20, further comprising the device generating the session key based at least in part on the host token and the device token.

25. The method of claim 20, further comprising the interface providing encrypted communication between the debugging entity and the device based at least in part on the session key.
